(19) United States
(12) Patent Application Publication
(10) Pub. No.: US 2025/0107491 A1
(43) Pub. Date: Apr. 3, 2025

(54) CORN STALK ROLLER

(71) Applicant: James Kahle, Marengo, IA (US)

(72) Inventor: James Kahle, Marengo, IA (US)

(21) Appl. No.: 18/901,552

(22) Filed: Sep. 30, 2024

Related U.S. Application Data
(60) Provisional application No. 63/586,910, filed on Sep. 29, 2023.

(51) Int. Cl. A01D 45/02

(52) U.S. Cl. CPC A01D 45/025

(57) ABSTRACT

Disclosed is corn stalk roller configured to roll and crimp stubs of corn stalks.

### CROSS-REFERENCE TO RELATED APPLICATIONS

This application claims the benefit of U.S. Provisional Patent Application No. 63/586,910 which was filed with the United States Patent and Trademark Office on Sep. 29, 2023, the entire contents of which is herein incorporated by reference.

### BACKGROUND

### 1. Field

Example embodiments relate to a mechanism designed to flatten and crimp corn stalks.

### 2. Description of the Related Art

When corn harvesting machines harvest corn they generally leave stubs of corn stalks in the ground. The stubs of corn stalks present a potential hazard for farm workers and equipment as the stubs can be quite stiff and sharp. In fact, the stubs may be stiff and sharp enough to damage farm equipment, for example, tires. To protect workers and equipment, harvesting machines are often fitted with devices, sometimes known as stompers, to flatten the stubs of corn stalk. Such devices often resemble a curved plate biased towards the ground to push the corn stalks over so they are no longer vertical. Such devices sometimes break the stubs of corn stalks enhancing their tendency to decay.

### SUMMARY

The inventor has noted that while devices that push over stubs of corn stalks are relatively effective at flattening stubs of corn stalks, they are not particularly effective at promoting stalk decay. As such, the inventor set out to design a new device which not only flattens stubs of corn stalks but crimps them as well. Crimping allows water and air to enter the stubs of corn stalks to facilitate faster decay.

In example embodiments an exemplary corn stalk roller is disclosed. The exemplary corn stalk roller includes a frame, a roller attached to the frame, an interfacing member pivotally attached to the frame, and a biasing member. In use, the corn stalk roller may be attached to a bar of an agricultural machine, for example, a corn head, to flatten and crimp stubs of corn stalks.

### BRIEF DESCRIPTION OF THE DRAWINGS

Example embodiments are described in detail below with reference to the attached drawing figures, wherein:

FIG. 1 is a perspective view of a corn stalk roller in accordance with example embodiments;

FIG. 2 a view of a side rail in accordance with example embodiment;

FIG. 3A is a view of a roller in accordance with example embodiments;

FIG. 3B is a view of a body of the roller in accordance with example embodiments;

FIG. 3C is a view of an end plate in accordance with example embodiments;

FIG. 3D is a view of a blade in accordance with example embodiments;

FIG. 3E is a first perspective view of a roller body showing an end plate arranged at a first end of the roller body in accordance with example embodiments;

FIG. 3F is a second perspective view of the roller body showing another end plate arranged at a second end of the roller body in accordance with example embodiments;

FIG. 3G illustrates another example of a roller body and end plates in accordance with example embodiments;

FIG. 4A is a view of side rails attached to a roller in accordance with example embodiments;

FIG. 5A is a view of a cross member in accordance with example embodiments;

FIG. 5B is a cross-section view of a cross member in accordance with example embodiments;

FIG. 5C is a view of a main body of a cross member in accordance with example embodiments;

FIG. 5D is a view of cross member end plates in accordance with example embodiments;

FIG. 6 is a view of the cross member attached to side rails in accordance with example embodiments;

FIG. 7A is a top view of an interfacing member in accordance with example embodiments;

FIG. 7B is a side view of an interfacing member in accordance with example embodiments;

FIG. 7C is a view of a plate used to construct an arm of an interfacing member in accordance with example embodiments;

FIG. 8 is a view of the roller, cross member, and interfacing member connected to side rails in accordance with example embodiments;

FIG. 9 is another example of a corn stalk roller in accordance with example embodiments;

FIG. 10A illustrates a perspective view of a bracket in accordance with example embodiments;

FIG. 10B illustrates a top view of a bracket in accordance with example embodiments;

FIG. 10C shows an arm of an interfacing member connected to bracket in accordance with example embodiments;

FIG. 11 illustrates an example of a corn stalk roller attached to an agricultural machine in accordance with example embodiments; and

FIG. 12 illustrates multiple corn stalk rollers attached to an agricultural machine in accordance with example embodiments.

### DETAILED DESCRIPTION

Example embodiments will now be described more fully with reference to the accompanying drawings, in which example embodiments of the invention are shown. The invention may, however, be embodied in different forms and should not be construed as limited to the example embodiments set forth herein. Rather, these example embodiments are provided so that this disclosure will be thorough and complete, and will fully convey the scope of the invention to those skilled in the art. In the drawings, the sizes of components may be exaggerated for clarity.

In this application, it is understood that when an element or layer is referred to as being “on,” “attached to,” “connected to,” or “coupled to” another element or layer, it can be directly on, directly attached to, directly connected to, or directly coupled to the other element or layer or intervening elements that may be present. In contrast, when an element is referred to as being “directly on,” “directly attached to,” “directly connected to,” or “directly coupled to” another element, there are no intervening elements present. As used herein, the term “and/or” includes any and all combinations of one or more of the associated listed items.

In this application it is understood that, although the terms first, second, etc. may be used herein to describe various elements and/or components, these elements and/or components should not be limited by these terms. These terms are only used to distinguish one element, component, region, layer, and/or section from another elements, component, region, layer, and/or section. Thus, a first element, component region, layer or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the structure in use or operation in addition to the orientation depicted in the figures. For example, if the structure in the figures is turned over, elements described as “below” or “beneath” other elements or features would then be oriented “above” the other elements or features. Thus, the exemplary term “below” can encompass both an orientation of above and below. The structure may be otherwise oriented (rotated 90 degrees or at other orientations) and the spatially relative descriptors used herein interpreted accordingly.

Embodiments described herein will refer to planform views and/or cross-sectional views by way of ideal schematic views. Accordingly, the views may be modified depending on manufacturing technologies and/or tolerances. Therefore, example embodiments are not limited to those shown in the views, but include modifications in configurations formed on the basis of manufacturing process. Therefore, regions exemplified in the figures have schematic properties and shapes of regions shown in the figures exemplify specific shapes or regions of elements, and do not limit example embodiments.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments relate to a corn stalk roller. In example embodiments, the corn stalk roller may attach to a bar of an agricultural machine, for example, a corn head, to push over and crimp cut stalks of corn.

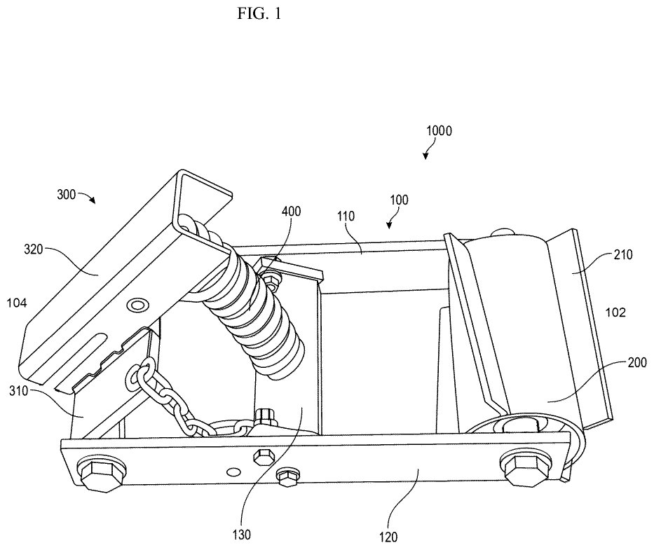

FIG. 1 is a view of a corn stalk roller 1000 in accordance with example embodiments. As shown in FIG. 1, the corn stalk roller 1000 includes a frame 100, a roller 200 rotationally attached to the frame 100, an interfacing member 300 pivotally attached to the frame 100, and a biasing member 400. In use, the corn stalk roller 1000 may be attached to a bar of an agricultural machine, for example, a corn head, to flatten and crimp stubs of corn stalks.

In example embodiments the frame 100 may include a first end 102 and a second end 104. Extending between the first end 102 and the second end 104 are a pair of side members 110 and 120 (also called side rails) which, in one embodiment, may be a pair of elongated plates. The side members 110 and 120 however, may be fabricated using other structural members such as angle iron, channel iron, tube steel, and the like. Spanning between the side members 110 and 120 is a cross member 130 which may also resemble a plate (or a combination of plates) but may also be formed from some other structural member such as angle iron, channel iron, tube steel, and the like. In example embodiments the cross member 130 connects the side members 110 and 120 together to form a substantially unitary structure. For example, the cross member 130 may be attached to the side members 110 and 120 by welding, bolting, or clipping. In the alternative, the side members 110 and 120 and the cross member 130 may be formed from a casting process and thus may form one integral member.

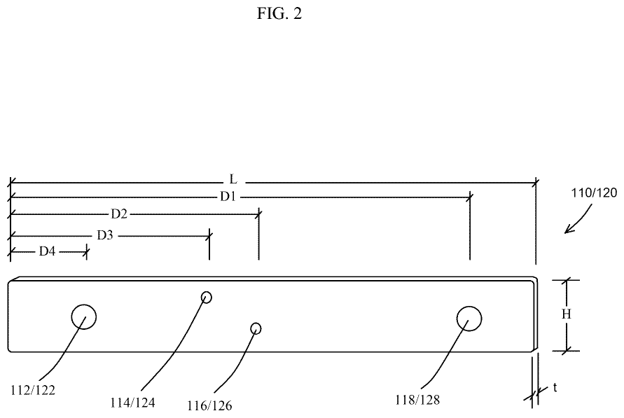

FIG. 2 provides additional details of the exemplary side members 110 and 120 (which may be, but is not required to be, substantially identical). Referring to FIG. 2, the side members 110/120 may resemble elongated plates having a length L, a height H, and a thickness t. As shown in FIG. 2, the side members 110 and 120 may each include four apertures 112/122, 114/124, 116/126/ and 118/128. The apertures 112/122 may facilitate connecting the frame 100 to the interfacing member 300. The apertures 114/124 and 116/126 may facilitate connecting the side members 110/120 to the cross member 130. The apertures 118/128 may facilitate connecting the roller 200 to the frame 100. Without intending to limit the invention, the length L of the side members 110/120 may be twenty inches and the height H may be about three inches. Apertures 118/128 may have a distance D1 of about eighteen inches from a second end of the side members 110/120. The apertures 116/126 may have a distance D2 of about twelve inches from the second end of the side members 110/120. The apertures 114/124 may have a distance D3 of about ten and a half inches from the second end of the side members 110/120. The apertures 112/122 may have a distance D1 of about one and half inches from the second end of the side members 110/120. It is understood the dimensions are for illustration only and not for limitation. For example, D4 may be about four and a half inches. The thickness t of the side members 110/120 may vary from one embodiment to another. For purpose of illustration only, the thickness of the side members 110 and 120 is generally constant along a length of the side members 1101 and 120 and may be ⅛″, ¼″, ⅜″, ½″, ⅝″, ¾″, or ⅞″ or whatever a skilled artisan determines is a proper thickness for the side members 110 and 120. In example embodiments, the apertures 114/124 and 116/126 may not be on a centerline of the side members 110/120. For example, the apertures 114/124 may each be offset from the upper and lower edges of the side members 110/120 by ¾″. Having the apertures 114/124 and 116/126 offset from the centerline of the side members 110/120 may facilitate a proper orientation of the cross member 130 in the corn stalk roller 1000.

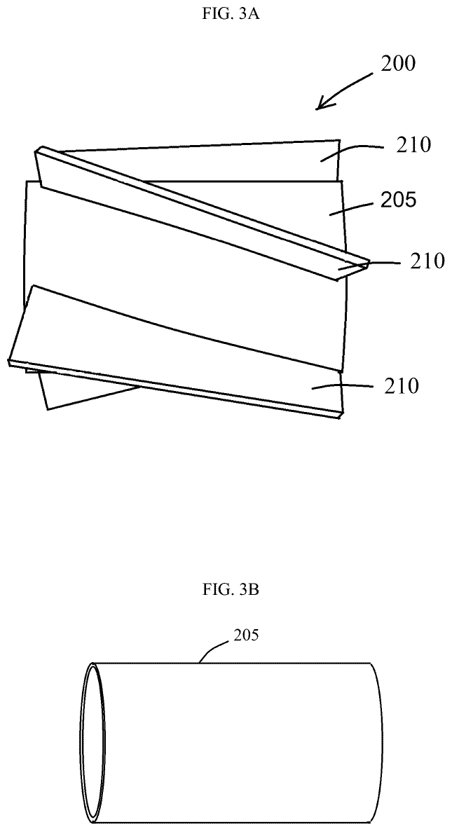

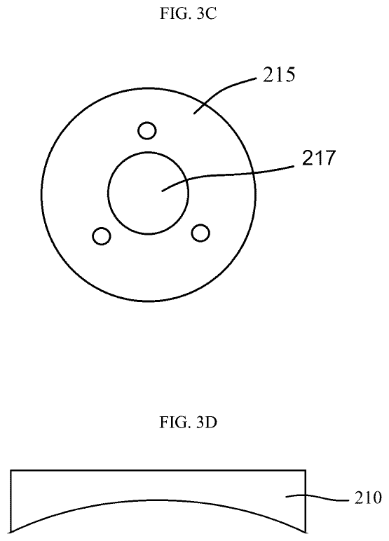

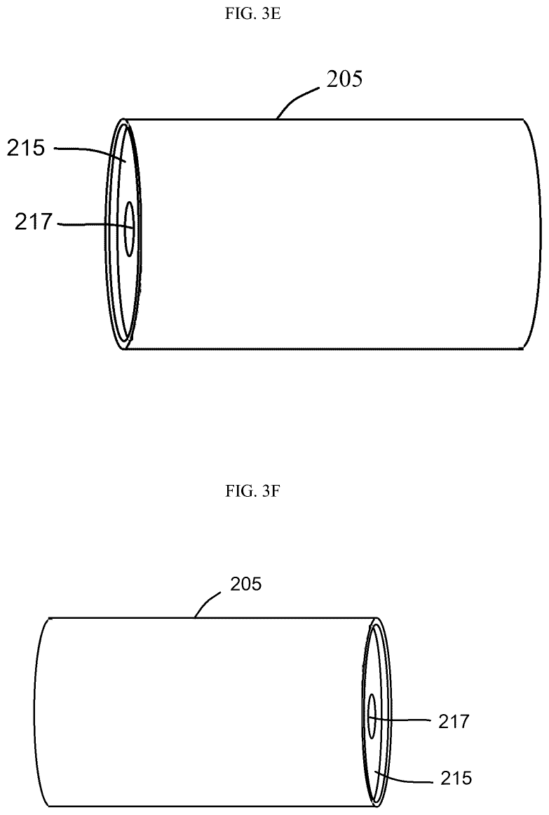

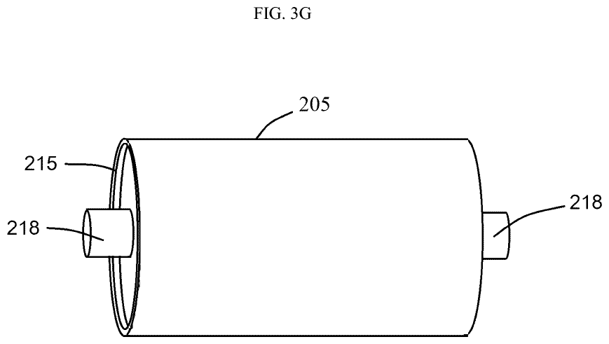

FIG. 3A is a front view of the exemplary roller 200. FIG. 3B shows a body 205 of the roller 200. FIG. 3C shows a side view of the roller 200 (without the blades) and FIG. 3D shows a blade 210 of the roller 200. In example embodiments the roller 200 may be rotationally attached to the first end 102 of the frame 100 and may be attached so that it can spin as the corn stalk roller 1000 is dragged along the ground. On the roller 200 the blades 210 may extend along a length of the roller 200 to cut into and crimp any stubs of cornstalks it comes in contact with. In the example embodiment shown in the figures the blades 210 are somewhat angled with respect to a centerline of the roller 200 to facilitate cutting into and opening a stub of cornstalk, however, in another embodiment they may be placed parallel with a centerline of the roller 200. Also, as shown in FIG. 1, the blades 210 may extend along an entire length of the roller body 205 without interruption.

As shown in FIG. 3A, the roller 200 may include various elements including a body 205, blades 210, and end plates 215 which may fit inside the body 205 to facilitate properly connecting the roller 200 to the frame 100. In example embodiments, the body 205 may resemble a hollow cylinder which may have a length of about nine inches, an outer diameter of about five inches and a wall thickness of about one quarter of an inch. Consequently, the diameter of the end plates 215 (which maybe arranged at each end of the body 205) may have a diameter of about four and a half inches to fit within the body 205. Arranged near and/or at the center of the end plate 215 is an aperture 217 which may be used to facilitate rotationally connecting the roller 200 to the frame 100. In one embodiment, the diameter of the aperture 217 may be about the same as the diameters of the apertures 118 and 128. Also, the blades 210 may have a length of about nine inches and a depth of about 0.5″, 0.75″, 1″, 1.25″, 1.5″, 1.75 inches or whatever is determined appropriate by the skilled artisan. It is understood the dimensions provided are for the purpose of illustration only and not limitation since a skilled artisan may vary the dimensions of the roller 200 without departing from the inventive concepts described herein. The blades 210 may be somewhat rectangular shaped. However, in at least one example embodiment, a bottom of the blade is contoured to properly fit on the roller body 205 when the blades are not parallel with an axis of the roller body.

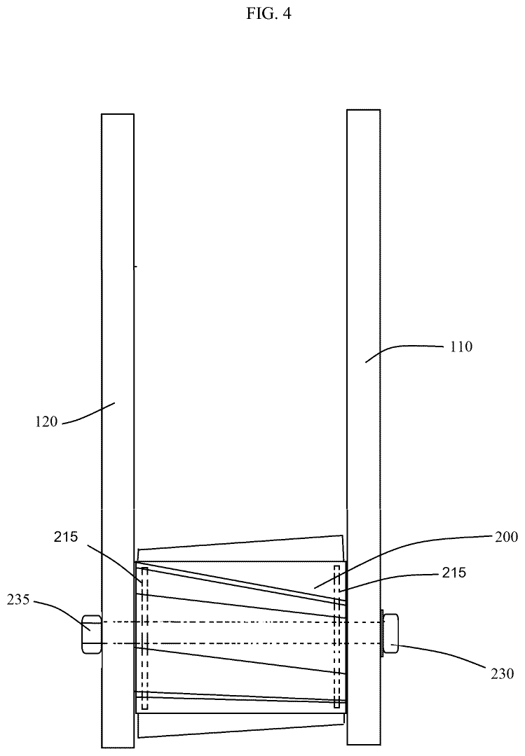

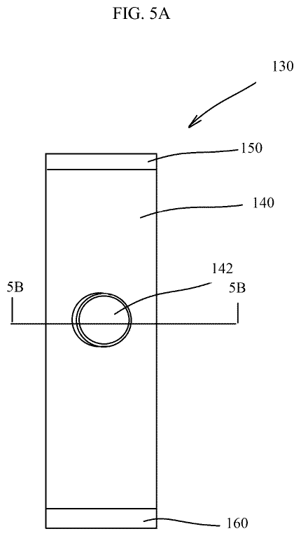

As mentioned above, the roller 200 may be rotationally supported by the frame 100. One skilled in the art would understand various ways in which this type of connection may be facilitated. For example, referring to FIG. 4, an axis of the roller 200 may be aligned with apertures 118 and 128 of side members 110 and 120. This aligns the apertures 217 of the end plates 215 with the apertures of 118 and 128 of the side members 110 and 120. A bolt 230 may then be passed through aperture 118 of the first side member 110, through the aperture 217 of a first end plate 215 arranged at one end of the roller 200, through aperture 217 of a second end plate 215 arranged at a second end of the roller 200 and through aperture 128 of the second side member 120 where a nut 235 is used to secure the bolt 230 in place. In this nonlimiting example, the roller 200 would be free to rotate around the bolt 230 while the corn stalk roller 1000 is driven over the ground. It is understood the rotational connection may be achieved by other means so the instant connection method is meant for purposes of illustration only, rather than limitation. For example, in another embodiment, the roller 200 may be comprised of a body 205, blades 210, and end plates 215, however, rather than having apertures 217 configured to receive a pin/bolt 230 to facilitate a rotational connection the end plates 215 may include pins 218 extending therefrom which may be insertable into apertures 118/129 of the side members 110 and 120.

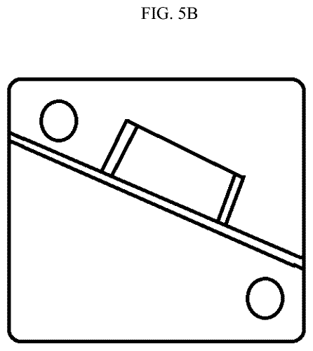

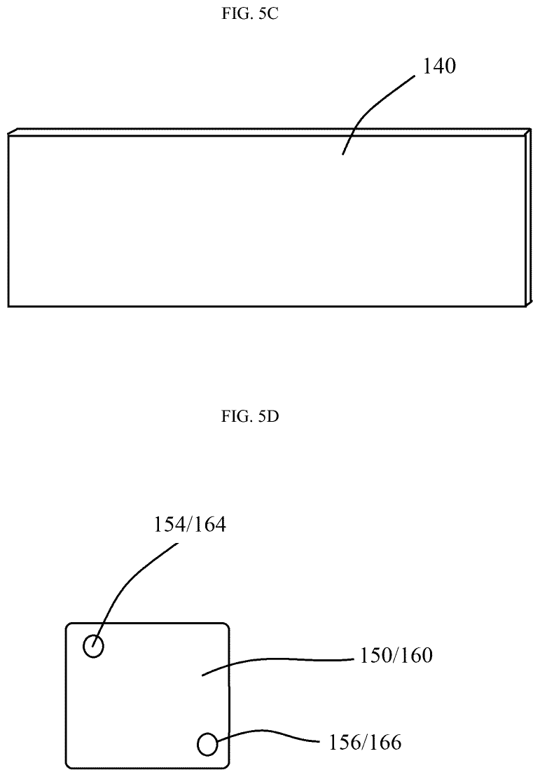

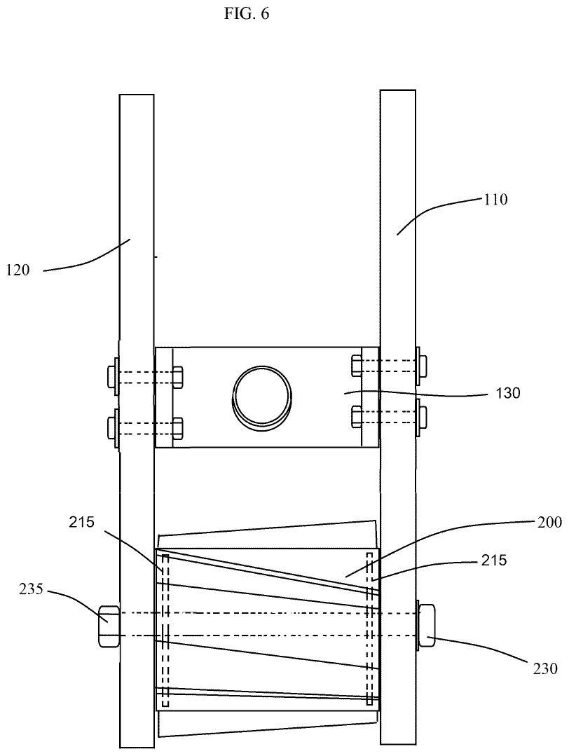

FIG. 5A is a top view of the cross member 130. As shown in FIG. 5A, the exemplary cross member 130 may be comprised of main body 140, a first end plate 150, and a second end plate 160. The main body 140 may resemble a plate having a length of about eight and one half inches, a depth of about three inches, and thickness of about a half an inch. On the main body 140 is a projection 142 which may resemble a short cylinder. As will be explained, the projection 142 may be a structure to which the biasing member 400 may attach. In example embodiments, the main body 140 may be supported in an inclined manner (see FIG. 5B) by the end plates 150 and 160 which in turn may be connected to the side members 110 and 120 by fasteners. For example, in example embodiments, the first end plate 150 may include a pair of holes 154 and 156 which may be aligned with the apertures 114 and 116 of the first side member 110. Similarly, the second end plate 160 may include a pair of apertures 164 and 166 which are alignable with apertures 124 and 126 of the second side member 120. Conventional fasteners, for example, screws and bolts, clips, etc. may then be used to connect the end plates 150 and 160 to the side members 110 and 120 as shown in FIG. 6. As in the previous example, the dimensions disclosed herein are for the purpose of illustration only and is not meant to limit the invention. Also, in example embodiments, the cross member 130 may be fabricated from three different plates (two for end plates 150 and 160 and one for the main body 140 which are then welded together, however, in another embodiment the cross member 130 may be formed through a casting process thus making the cross member 130 having a main body 140 and end plates 150 and 160 a substantially integral structure. Further, in example embodiments one skilled in the art would recognize multiple ways of connecting the cross member 130 to the side member 110 and 120, for example, using bolts and/or clips. Thus, the aforementioned means of connecting the cross member 130 to the side members 110 and 120 is meant for the purpose of illustration rather than by limitation. Further yet, the cross member may, instead of being formed from three plates may be constructed using another type of structural member, for example, angle iron or tube steel to connect the side members 110 and 120 together and to provide a means to support the biasing member 400.

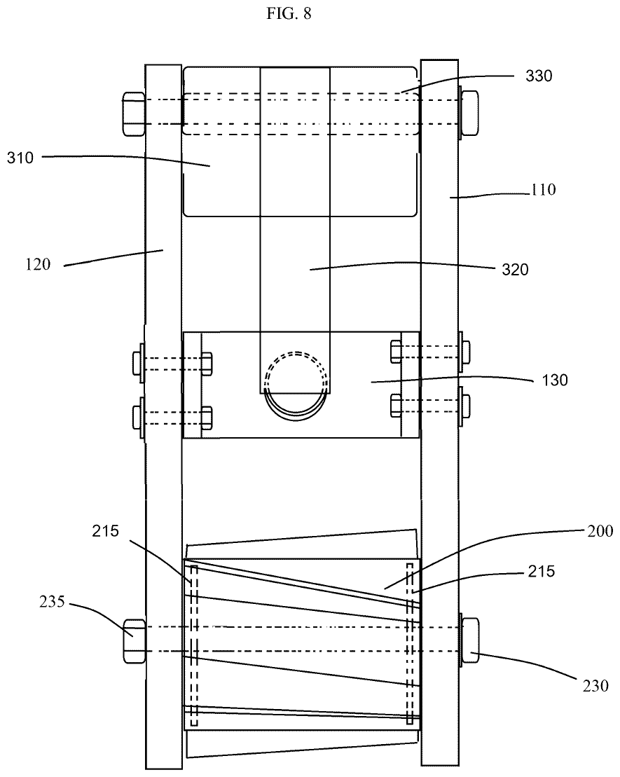

In example embodiments the interfacing member 300 may be pivotally attached to the second end 104 of the frame 100. The interfacing member 300 may, in one nonlimiting example embodiment, include a baseplate 310, an arm 320, and a connecting member 330 which facilitates pivotally connecting the interfacing member 300 to the frame 100. The interfacing member 330, for example, may resemble a cylindrical tube which may receive a fastener, for example, a bolt, which may be used to connect the interfacing member 300 pivotally to the frame 100. By way of example only, the interfacing member 330 may resemble a metal tube having an outer diameter of one and three eights inches, an inner diameter of about one inch, and a length of about eight to nine inches. In example embodiments, the connecting member 330 may extend along a substantial portion of the baseplate 310 and may be alignable with the apertures 112/122 of the first and second side members 110 and 120. A bolt may be passed through the each of the apertures 112/122 and the connecting member 330 to facilitate a pin type connection to the frame 100. In this manner, the interfacing member 300 may be pivotally connected to the frame 100 via the connection through the connecting member 330. Such a connection is illustrated best in FIG. 8

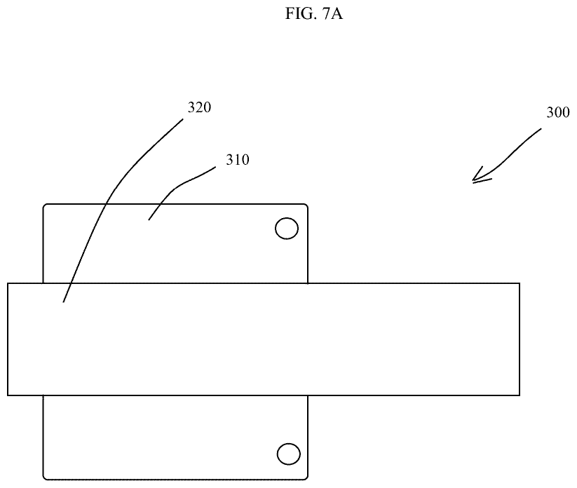

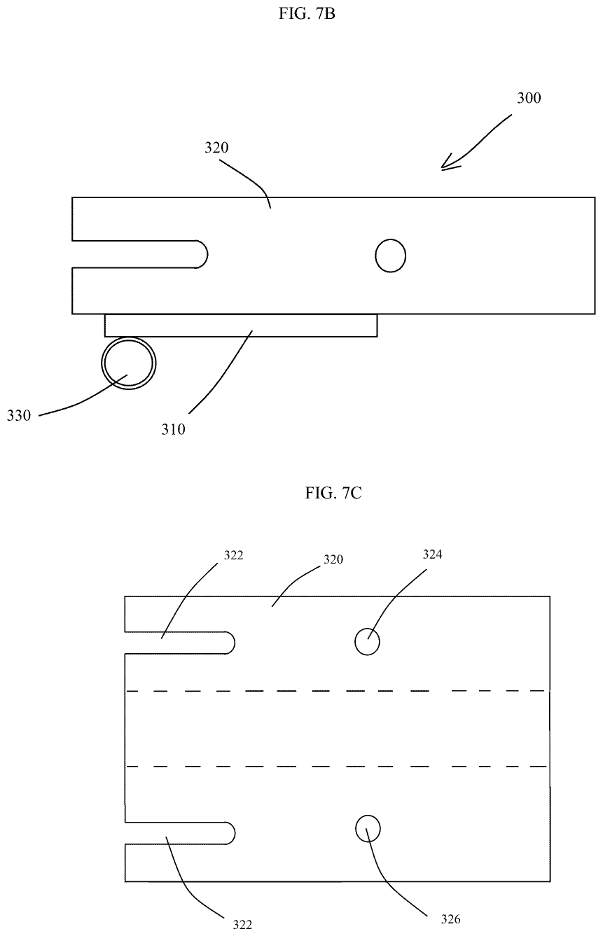

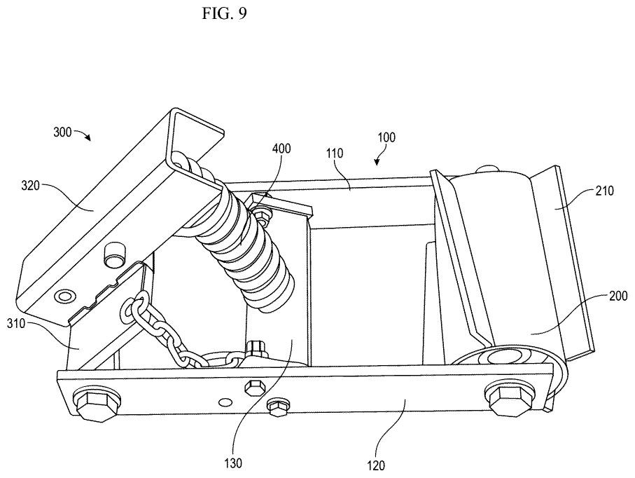

FIG. 7A shows a top view of the interfacing member 300 and FIG. 7B shows a side view of the interfacing member. In example embodiments, the base plate 310 may resemble a plate having a length of about nine inches and a width of about six inches. The arm 320 may have a substantially U-shaped cross-section and may, in at least one nonlimiting example embodiment, have slits 322 which may be used to facilitate an interface with a bracket of an agricultural machine. In another embodiment, the arm 320 has a stub which interfaces with a slot of a bracket attached to an agricultural machine (see FIG. 9). Regardless, in at least one nonlimiting example embodiment, the arm 320 may be made from a single plate where the slits are formed. Holes 324 and 326 may also be formed in the plate to facilitate connecting the interfacing member 300 to the aformentioned bracket. The plate may be folded along fold lines (dashed lines of FIG. 7C) to form the arm 320.

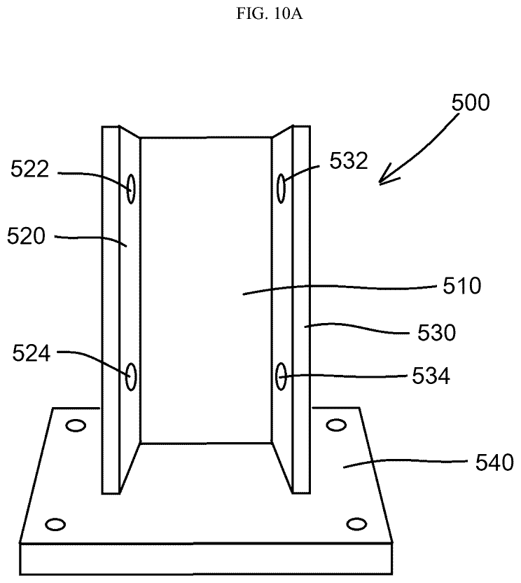

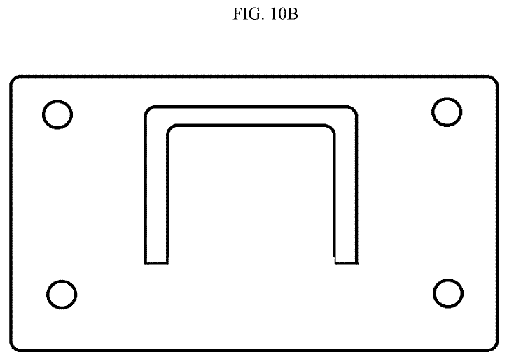

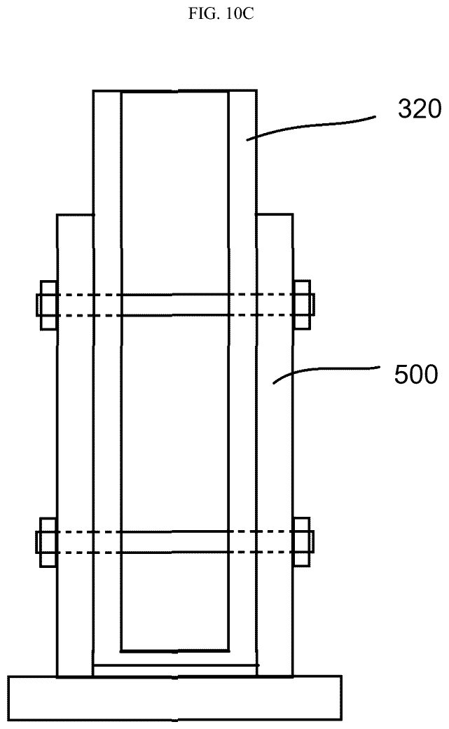

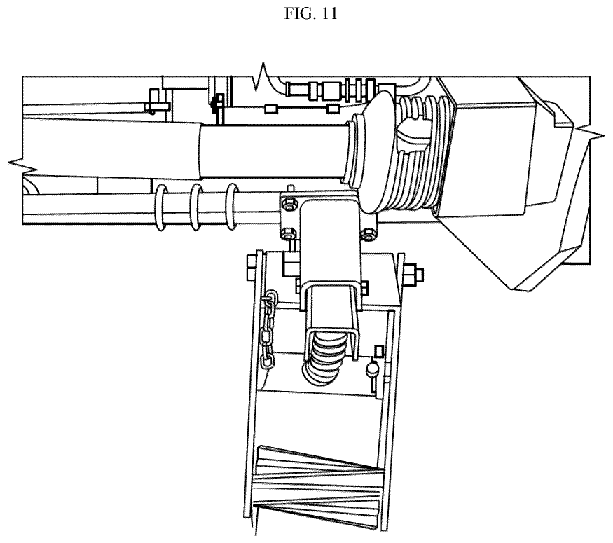

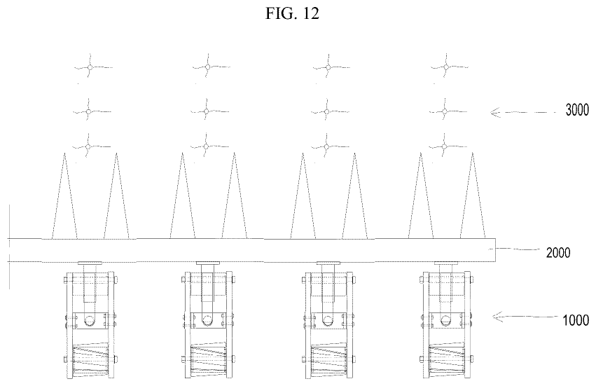

FIGS. 10A-10C are views of a bracket 500 usable with at least one example embodiment. As shown in FIGS. 10A-10C the bracket 500 may include a body having a somewhat U-shaped cross-section sized to accommodate the arm 320 of the interfacing member 300. In example embodiments the body may be comprised of a first wall 510, a first side wall 520, a second side wall 520, and a base plate 540. The baseplate may include apertures (shown but not labeled) for attaching the bracket 500 to an agricultural machine (for example, a corn head). The first side wall 520 may include a pair of apertures 522 and 524 to enable a connection with the arm 320 of the interfacing member 300. Similarly, the second side wall 530 may include a pair of apertures 532 and 534 which may enable a connection with the arm 320 of the interfacing member 300. In one example embodiment, when attached, the slots 322 of the arm 320 are aligned with the apertures 524 and 534 of the body and the apertures 522 and 532 of the body are aligned with the apertures 324 and 326 of the arm 320. Fasteners, for example, pins and bolts, may be used to secure the connection as shown in FIG. 10C.

In example embodiments, the corn stalk roller 1000 may be attached to the agricultural machine at a substantially single spot via the arm 320. Thus, installation of the corn stalk roller 1000 does not require locating more than one attachment point to attach the corn stock roller 1000 to an agricultural machine.

In example embodiments, the biasing member 400, for example, a spring, may be attached to the arm 320 of the interfacing member 300 and the cross member 130 of the frame 300. For example, one end of the biasing member 400 may be attached to the arm 320 by a conventional means such as a screw, clip, and or weld while a second end of the biasing member 400 may attach to the cross member 130 of the frame 100. For example, the biasing member 400 may be a coil spring having an end that is clipped to the projection 142 of the cross member 130. In use the biasing member 400 applies a force against the cross member 130 thereby exerting a force on the roller 200 via the frame 100. This prevents the frame 100 from excessive movement while applying a down pressure on the roller 200 to facilitate crimping of corn stalks it comes in contact with.

In example embodiments multiple corn stalk rollers 1000 may be attached to the agricultural machine 2000 and spaced apart so they align with rows of corn stalks 3000 such that when the agricultural machine 2000 cuts the corn 3000 and the machine 2000 passes over the stubs of corn stalks the corn stalk roller 1000 presses down, rolls over, and crimps the stubs of corn stalks. Having multiple corn stalk rollers 1000 allows a user to replace one or more corn stalk rollers 1000 at different times in the event they wear unevenly. Furthermore, having the corn stalks crimped by the blades 210 facilitates opening the corn stalks leading to intake of moisture which facilitates decay of the corn stalks. Further yet, having multiple corn stalk roller 1000 allows for effective rolling and crimping of stubs of corn when the ground is uneven. Further yet, in some embodiments, the corn stalk rollers 1000 are configured to only pass over a single rows of corn stalks. Thus, unlike conventional crimpers which span several rows of corn stalks, the corn stalk rollers 1000 are able to target a single row or corn stalks and do not suffer the drawbacks of conventional rollers which often have a problem with uneven ground.

Example embodiments of the invention have been described in an illustrative manner. It is to be understood that the terminology that has been used is intended to be in the nature of words of description rather than of limitation. Many modifications and variations of example embodiments are possible in light of the above teachings. Therefore, within the scope of the appended claims, the present invention may be practiced otherwise than as specifically described.

What is claimed is:

1. A corn stalk roller comprising:
a frame;
a roller attached to the frame;
an interfacing member pivotally attached to the frame; and
a biasing member.

2. The corn stalk roller of claim 1, wherein the roller is free to spin on a first end of the frame.

3. The corn stalk roller of claim 1, wherein the roller includes a plurality of blades.

4. The corn stalk roller of claim 3, wherein the plurality of blades extend along a length of the roller.

5. The corn stalk of roller of claim 4, wherein the plurality of blades extend across an entire length of the roller.

6. The corn stalk roller of claim 1, wherein the interfacing member includes a single arm to provide a single attachment of the corn stalk roller to an agricultural machine.

7. The corn stalk roller of claim 1, wherein the spring attaches to a cross member of the frame and an arm of the interfacing member.

8. The corn stalk roller of claim 1, wherein the spring biases the roller downwards to apply pressure from the roller to stubs of corn stalks.

9. The corn stalk roller of claim 1, wherein the roller is rotationally attached to a first end of the frame and the interfacing member is attached to a second end of the frame.

10. The corn stalk roller of claim 1, wherein the frame includes a first side member and a second side member and a cross member connecting the first side member to the second side member.

11. The corn stalk roller of claim 1, wherein the first side member and the second side member are parallel.

12. The corn stalk roller of claim 1, wherein the frame includes a first side member and a second side member and the interfacing member includes an arm which is substantially equidistant from the first side member and the second side member.
